(19) United States
(12) Patent Application Publication
(10) Pub. No.: US 2023/0344206 A1
(43) Pub. Date: Oct. 26, 2023

(54) Tamper Resistant Covers for Hose and/or Cable Connectors

(71) Applicant: Nautical Control Solutions, LP, Spring, TX (US)

(72) Inventors: Thomas Smith, Houston, TX (US); Emerson Ornstein, Houston, TX (US); Brian Doyle, Conroe, TX (US); Anthony George, The Woodlands, TX (US)

(21) Appl. No.: 18/300,255

(22) Filed: Apr. 13, 2023

Related U.S. Application Data
(60) Provisional application No. 63/363,371, filed on Apr. 21, 2022.

(51) Int. Cl. H02G 3/06; F16L 55/00

(52) U.S. Cl. CPC H02G 3/0616; F16L 55/00

(57) ABSTRACT

Tamper-proof covers for enclosing hose connectors or cable connectors are described. The tamper proof covers may include first and second sections configured to fit about the long axis of the connector and to join to cover at least a portion of the connector so that the connector cannot be disconnected without removing the cover. The sections may be held in place using a cable seal, which must be cut to remove the cover.

### CROSS REFERENCE TO RELATED APPLICATIONS

This is a non-provisional of U.S. Provisional patent application Ser. No. 63/363,371, filed Apr. 21, 2022, to which priority is claimed, and which is incorporated herein by reference.

### INTRODUCTION

Various types of connectors are used connect hoses and/or cables to each other or to equipment and components. In some environments there is a need to secure such connections against tampering. For example, U.S. Pat. No. 7,024,317(“the '317 Patent”), the entire contents of which are incorporated herein by reference, describes a fuel monitoring system for monitoring fuel usage in a vehicle, such as ship. The system described in the '317 Patent features flow meters installed on the fuel line used to fill the fuel tank, on the fuel line from the tank to the engine, and on the fuel line that returns unburned fuel from the engine back to the tank. Each of these respective fuel lines are connected to the flow meters using hose connectors. Measurements from each of the flow meters can be used to maintain accountability regarding fuel transferred to and used by the vessel. A person seeking to circumvent the fuel monitoring system might attempt to disconnect the fuel lines from one or more of the meters.

Other example of systems that involve connections of hoses or cables with equipment include security camera (e.g., CCTV) equipment, security alarms, and the like. For example, data cables in such systems may connect to each other or to equipment using connectors, such as BNC connectors, RJ45 connectors, or the like. Such connections may provide a target for a person seeking to circumvent the system. Accordingly, there is a need in the art for methods and systems for securing such connectors against tampering.

### SUMMARY

Disclosed herein is a system for securing a conduit connector, the system comprising: a connector cover comprising first and second sections, wherein the first and second sections each comprise an outside surface, an inside surface, and two edge surfaces, wherein the first and second sections are positionable about a long axis of the conduit connector so as to meet at their respective edge surfaces and enclose at least a portion of the conduit connector, and wherein the outside surface of each of the sections comprises at least one feature configured to accommodate a seal to maintain the first and second sections about the conduit connector. According to some embodiments, the first and second sections each comprise halves of the connector cover. According to some embodiments, the edge surfaces of the first and second sections are planar. According to some embodiments, the at least one feature configured to accommodate a cable seal comprises one or more grooves. According to some embodiments, the at least one feature configured to accommodate a cable seal comprises one or more holes. According to some embodiments, the inside surface of each of the first and second sections comprise one or more features shaped to conform to a surface of one or more components of the conduit connector. According to some embodiments, the surface of one or more components of the conduit connector is a hexagonal surface. According to some embodiments, the one or more features shaped to conform to a surface of one or more components of the conduit connector comprises a groove configured to conform to a surface of a nut on the conduit connector. According to some embodiments, the system further comprises the cable seal. According to some embodiments, the cable seal comprises: a body, a cable having a first end and a second end, wherein the first end is permanently connected to the body, and a locking mechanism within the body configured to lock the cable in place when the second end of the cable is inserted through the body via a shackle passageway. According to some embodiments, each of the first and second sections are formed of a material selected from the group consisting of polyvinyl chloride (PVC), polyoxymethylene (POM), acrylonitrile butadiene styrene (ABS), and combinations thereof. According to some embodiments, the conduit is a hose configured to conduct fuel. According to some embodiments, the conduit connector is configured to connect the hose to a flow meter. According to some embodiments, the conduit is a data cable. According to some embodiments, the conduit connector is configured to connect the data cable to a camera or to a component of an alarm system.

### BRIEF DESCRIPTION OF THE DRAWINGS

FIG. 1 shows a connector for connecting a conduit, such as a hose, to a piece of equipment.

FIG. 2 shows a tamper-proof cover disposed upon a connector.

FIG. 3 shows two views of a section of a tamper-proof cover.

FIG. 4 shows half of a tamper-proof cover for a connector disposed on a connector.

FIG. 5 shows a cable seal for sealing a tamper-proof cover for a connector.

FIG. 6 shows a tamper-proof cover for a connector assembled and sealed with a cable seal.

### DETAILED DESCRIPTION

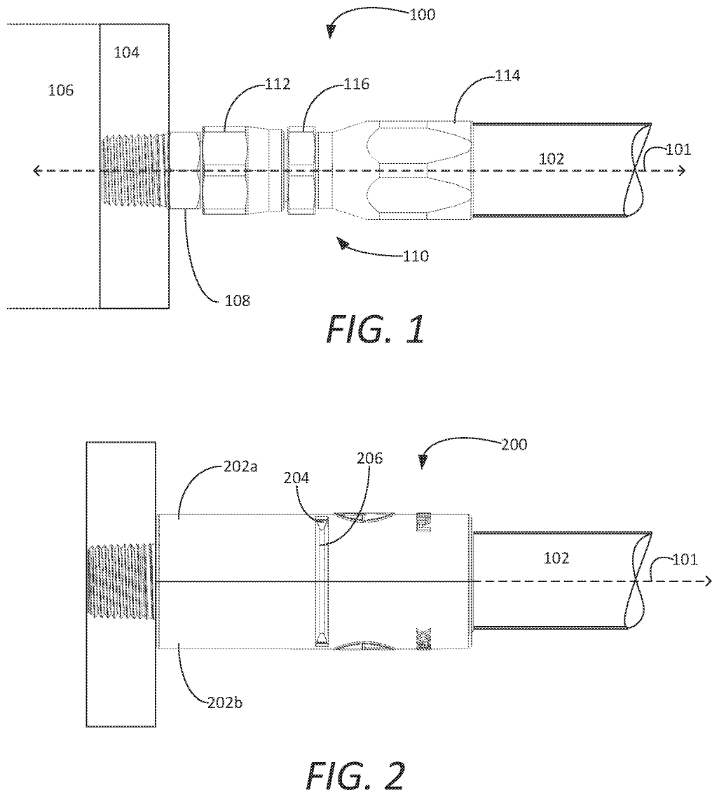

FIG. 1 illustrates an embodiment of a connector 100 connecting a conduit 102 to a side of a housing 104 of a piece of equipment 106. The connector 100 has a long axis 101. In the illustrated embodiment, the conduit is a hose, for example, a fuel hose. As mentioned above, the equipment 106 may be a flow meter or a fuel tank, for example. According to other embodiments, the conduit may be a cable, such as a data or camera cable, in which case, the equipment may be a camera, a component of an alarm system, or the like. As used herein, the term “conduit” may refer to hoses or the like, which may be used to transfer fluids, such as fuel. Conduit may also refer to cables, such as data cables, which may be used to transfer electricity and or data.

In the illustrated example, a threaded nipple or tube fitting 108 is threaded into the housing 104 and is configured to connect to a hose swivel fitting 110. The hose swivel fitting comprises a female threaded hex connection 112 that is configured to attach to a male threaded portion of the tube fitting 108 (not visible in the drawing). A person seeking to disconnect the conduit 102 from the equipment 106 would need to access the hex connection 112 and unscrew it from the threaded fitting 108. The swivel fitting 110 also comprises a hexagonal hose fitting section 114 that includes a hexagonal turning/gripping section 116. Those components could also be a target for a person seeking to unfasten the conduit 102.

It will be apparent to those of skill in the art that other configurations of connectors may be used for connecting a variety of conduits to equipment or to other conduits. For example, a cable connector, such as a BNC connector, may have a hex connection 112 like the one shown in FIG. 1 or may have a pin/slot locking mechanism, as is known in the art. Likewise, connectors such as RJ45 connectors have tabs/locking mechanisms that must be accessed. In any case, a person wishing to disconnect the conduit will need to access the connector locking mechanism (e.g., the hex connection or the pin/slot mechanism, etc.) to do so.

FIG. 2 illustrates an embodiment of a tamper-proof device for securing a conduit connector. The tamper-proof device comprises a cover 200 configured to enclose the connector. The cover 200 comprises a first section 202a and a second section 202b that are positionable about the long axis 101 of the connector. In the illustrated embodiment each of the sections 202a and 202b comprise half of cylinder, which, when joined, provide a cylinder around the connector. Each section 202 comprises a hole 204 and a groove 206, which are configured to accept a cable seal, as described in more detail below. Note that some embodiments may only comprise a hole 204 or may only comprise a groove 206.

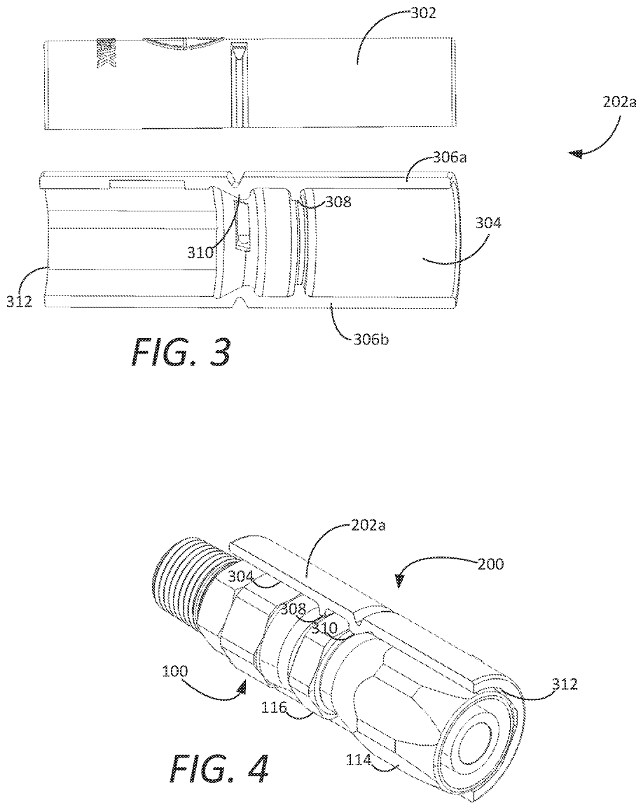

FIG. 3 illustrates two views of one of the sections 202a of the tamper-proof cover. Each section comprises an outer surface 302, an inner surface 304 and two edge surfaces 306a and 306b. The edge surfaces 306a and 306b are essentially planar in the illustrated embodiment. When the cover 200 is disposed upon the conduit connector, the planar edge surfaces of each of the sections meet with each other to form an enclosing arrangement about the conduit connector. According to other embodiments, the edge surfaces 306a and 306b may be configured with mating features, such as notches, grooves, detents, etc., that are configured to mate with complementary structures when the two pieces of the cover are assembled. As explained in more detail below, the inner surface 304 of each of the sections may be configured with one or more features, such as ridges 308 and 310, and hexagonal shaping 312, to accommodate, engage, or conform to corresponding features of the conduit connector.

FIG. 4 shows a section 202a of a cover 200 disposed on a connector 100. Notice that the inner surface 304 of the cover section is shaped to fit the shape of the connector and its components. For example, the inner surface comprises one or more features, such as ridges 308 and 310, to fit around components, such as the hexagonal turning/gripping section 116. Also, a portion of the inner surface of the cover is configured in a hexagonal in shape 312 to accommodate or conform to the hexagonal shape of the hose fitting section 114. Including one or more such features configured to mate with the underlying connector in the inner surface 304 of the cover 200 helps keep the cover from sliding down the conduit when the cover is assembled upon the connector. It should be noted that while the cover is generally shaped to accommodate the features of the underlying hose/connectors, the cover may not necessarily be exactly “form fitting.” In other words, the cover may be held in place, for example, by features like the ridges 308 and 310, to prevent a person from pushing or pulling the cover along the axis of the hose to slide it off in either direction. But the cover need not be form fitting. According to some embodiments, the inner diameter of the cover is adequately larger in diameter than the underlying connector, such that the cover doesn't grab the underlying connector (e.g., the hexagonal hose fitting 116) in a way that would allow the cover to be twisted to unhook the connector.

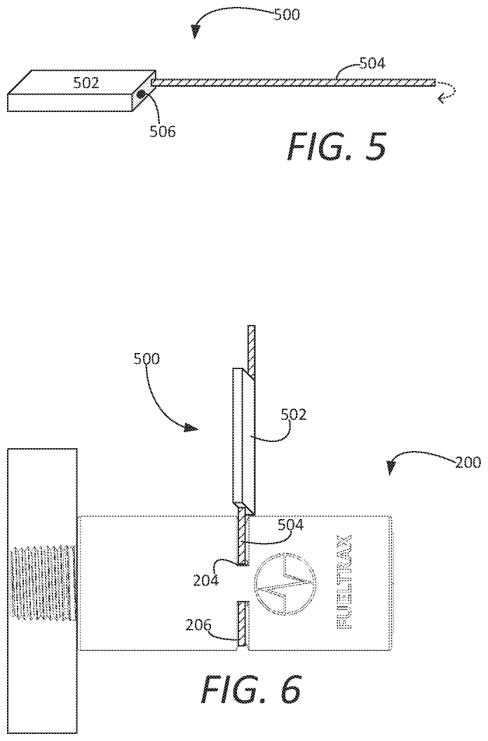

FIG. 5 illustrates an embodiment of a cable seal 500, which may be used in conjunction with the disclosed tamper proof devices. Cable seals are known in the art and will not be discussed here in detail. For example, U.S. Pat. No. 9,558,682 describes an embodiment of a cable seal. Suitable cable seals include the Cablelock 4 barcoded cable seal, which is available from Seals.Com (Plainview, New York). Briefly, the cable seal 500 comprises a body 502 and a cable, such as a banded cable 504. One end he cable 504 is securely fastened to the body. To implement the cable seal, the free end of the cable 504 is inserted into a shackle passageway 506 in the body. As the cable is pulled through the body, cinching the cable around whatever device is to be sealed, a locking mechanism (not shown) inside the body locks the cable in place. In other words, the cable can be tightened but cannot be loosened. Generally, the only way to remove the cable lock once it is secure is to cut the cable. According to some embodiments, the body of the cable seal may be marked with an identifying number, a bar code or the like. According to some embodiments, the cable seal may be equipped with an RFID feature. Such identifying features aid in tamper detection, since the cable seal cannot be simply replaced in the case of tampering. As used herein, the term “cable seal” may also refer any type of seal with an elongated structure, such as the banded cable 504, that is configurable to sinch the sections of the cover. Other examples of cable seals include zip ties (e.g., serialized zip ties), paper seals, and/or tape.

FIG. 6 illustrates the assembled cover 200 secured with the cable seal 500. Notice that the cable 504 is inserted through the hole 204 in the visible section of the cover 200. The cable 504 is also inserted in the corresponding how of the cover section that is not visible in the illustration. The cable is also fitted within the groove 206. The cable 504 is inserted through the body 502 of the cable lock and sinched tight to hold the cover 200 together. It should be pointed out that the illustrated embodiments of the tamper-proof devices do not rely on a lock or key. Instead, they are simply assembled over the coupling and held in place by the seal.

The disclosed tamper-proof coupling covers may be made from any suitable material, especially plastic materials, such as thermoplastics. Examples of suitable materials include polyvinyl chloride (PVC), polyoxymethylene (POM), acrylonitrile butadiene styrene (ABS), and the like, as well as blends/combinations thereof. Any of the materials may be reinforced with a material, such as fiberglass, for extra strength. The covers may be made using any techniques known in the art for fashioning plastic materials, such as injection molding, three dimensional printing (fused deposition modeling), extrusion, milling (e.g., CNC milling), and the like.

While the invention herein disclosed has been described in terms of specific embodiments and applications thereof, numerous modifications and variations could be made thereto by those skilled in the art without departing from the scope of the invention set forth in the claims.

1. A system for securing a conduit connector, the system comprising:
a connector cover comprising first and second sections, wherein the first and second sections each comprise an outside surface, an inside surface, and two edge surfaces,
wherein the first and second sections are positionable about a long axis of the conduit connector so as to meet at their respective edge surfaces and enclose at least a portion of the conduit connector, and
wherein the outside surface of each of the sections comprises at least one feature configured to accommodate a cable seal to maintain the first and second sections about the conduit connector.

2. The system of claim 1, wherein the first and second sections each comprise halves of the connector cover.

3. The system of claim 1, wherein the edge surfaces of the first and second sections are planar.

4. The system of claim 1, wherein the at least one feature configured to accommodate a cable seal comprises one or more grooves.

5. The system of claim 1, wherein the at least one feature configured to accommodate a cable seal comprises one or more holes.

6. The system of claim 1, wherein the inside surface of each of the first and second sections comprise one or more features shaped to conform to a surface of one or more components of the conduit connector.

7. The system of claim 6, wherein the surface of one or more components of the conduit connector is a hexagonal surface.

8. The system of claim 6, wherein the one or more features shaped to conform to a surface of one or more components of the conduit connector comprises a groove configured to conform to a surface of a nut on the conduit connector.

9. The system of claim 1, further comprising the cable seal.

10. The system of claim 9, wherein the cable seal comprises:
a body,
a cable having a first end and a second end, wherein the first end is permanently connected to the body, and
a locking mechanism within the body configured to lock the cable in place when the second end of the cable is inserted through the body via a shackle passageway.

11. The system of claim 1, wherein each of the first and second sections are formed of a material selected from the group consisting of polyvinyl chloride (PVC), polyoxymethylene (POM), acrylonitrile butadiene styrene (ABS), and combinations thereof.

12. The system of claim 1, wherein the conduit is a hose configured to conduct fuel.

13. The system of claim 12, wherein the conduit connector is configured to connect the hose to a flow meter.

14. The system of claim 1, wherein the conduit is a data cable.

15. The system of claim 14, wherein the conduit connector is configured to connect the data cable to a camera or to a component of an alarm system.
